(19) United States
(12) Patent Application Publication
(10) Pub. No.: US 2024/0326780 A1
(43) Pub. Date: Oct. 3, 2024

(54) Method And Apparatus For Determining Initial Location of Vehicle

(71) Applicants: Hyundai Motor Company, Seoul (KR); Kia Corporation, Seoul (KR)

(72) Inventor: Byung Hyun Lee, Seongnam-si (KR)

(21) Appl. No.: 18/533,300

(22) Filed: Dec. 8, 2023

(30) Foreign Application Priority Data
Mar. 31, 2023 (KR) 10-2023-0042619

(51) Int. Cl. B60W 30/02

(52) U.S. Cl. CPC B60W 30/02; B60W 60/001; B60W 2420/408; B60W 2554/4041

(57) ABSTRACT

An apparatus for determining an initial location of a vehicle is introduced. The apparatus may comprise a processor, and memory storing instructions, that, when executed by the processor, may cause the apparatus to receive, from a global navigation satellite system (GNSS), an initial GNSS location, generate, based on map information associated with the initial GNSS location, a first grid map, generate, based on sensing information from a sensor, a second grid map, detect, based on a comparison of the first grid map and the second grid map, a correlation peak for an initial location of a vehicle, and determine, based on the detected correlation peak, whether to set the initial location of the vehicle.

This application claims the benefit of Korean Patent Application No. 10-2023-0042619, filed on Mar. 31, 2023, which is hereby incorporated by reference as if fully set forth herein.

### TECHNICAL FIELD

The present disclosure relates to a method and apparatus for determining an initial location of a vehicle.

### BACKGROUND

An autonomous vehicle generally refers to a vehicle that drives to a destination by recognizing a driving environment by itself without operation of a driver. To use such an autonomous vehicle in urban areas, it is important to accurately recognize a driving environment. To this end, driving environment recognition technology that combines a GPS (global positioning system), map information, various sensors, could be considered.

For recognizing an exact location of a driving vehicle for autonomous driving, the location of the driving vehicle may be estimated by matching information between a precision map and a sensor installed in the vehicle in order to recognize the location of the driving vehicle.

### SUMMARY

The following summary presents a simplified summary of certain features. The summary is not an extensive overview and is not intended to identify key or critical elements.

The present disclosure relates to a method and apparatus for determining an initial location of a vehicle. According to the present disclosure, a method may comprise receiving, by a processor, map information associated with an initial global navigation satellite system (GNSS) location; generating, based on the map information associated with the initial GNSS location, a first grid map; generating, based on sensing information from a sensor, a second grid map; determining, based on a comparison of the first grid map and the second grid map, an initial location of a vehicle; and controlling, based on the initial location of the vehicle, a driving operation of the vehicle.

Generating the first grid map may comprise: setting a heading search range of angles for the vehicle in the map information; detecting a lane within the heading search range of angles; determining, based on the detected lane, heading information associated with the detected lane; and generating a heading candidate group for the vehicle based on the heading information of the detected lane.

The heading candidate group for the vehicle may comprise at least one heading candidate for the vehicle; and the at least one heading candidate for the vehicle is generated in units of a first angle within the heading search range of angles.

Generating the first grid map may comprise: setting a heading search range of angles for the vehicle in the map information; and maintaining a previous state of a lane based on no new lane being detected in the heading search range of angles.

The heading candidate group for the vehicle may comprise at least one heading candidate for the vehicle; and the at least one heading candidate for the vehicle is generated in units of a second angle within a range of a heading rotation angle of the vehicle set based on the initial GNSS location.

The method may further comprise: matching the second grid map with the first grid map by rotating the first grid map by a predetermined angle up to a preset angle range, determining a correlation value between the second grid map and the first grid map of each rotation, and determining a rotation of the first grid map having a correlation peak.

The method may further comprise: determining, based on the comparison, whether to set the initial location of the vehicle by setting the initial location of the vehicle based on the correlation peak being greater than or equal to a threshold correlation peak.

The method may further comprise: determining, based on the comparison, whether to set the initial location of the vehicle by setting the initial location of the vehicle when a length matched between the first grid map and the second grid map, which are calculated based on the set initial location of the vehicle, is greater than or equal to a preset reference length.

The method may further comprise: determining, based on the comparison, whether to set the initial location of the vehicle by: setting the initial location of the vehicle two times, wherein: based on a first of the two times set initial location of the vehicle, a first position of the vehicle is determined; and based on a second of the two times set initial location of the vehicle, a second position of the vehicle is determined; determining a probability of similarity between the first position of the vehicle and the second position of the vehicle; and completing a determination of the initial location of the vehicle based on the determined probability of similarity being greater than or equal to a predetermined value.

Generating the second grid map may comprise: accumulating the sensing information at least once under control of the processor; and generating the second grid map based on the accumulated sensing information.

According to the present disclosure, a non-transitory computer-readable recording medium storing instructions, that, when executed, may cause performing the method.

According to the present disclosure, an apparatus may comprise a processor; and memory storing instructions, that, when executed by the processor, cause the apparatus to: receive map information associated with an initial global navigation satellite system (GNSS) location; generate, based on the map information associated with the initial GNSS location, a first grid map; generate, based on sensing information from a sensor, a second grid map; determine, based on a comparison of the first grid map and the second grid map, an initial location of a vehicle; and control, based on the initial location of the vehicle, a driving operation of the vehicle.

The instructions, when executed by the processor, may further cause the apparatus to: set a heading search range of angles for the vehicle in the map information; detect a lane within the heading search range of angles; determine, based on the detected lane, heading information associated the detected lane; and generate a heading candidate group for the vehicle based on the heading information.

The heading candidate group for the vehicle may comprise at least one heading candidate for the vehicle; and the at least one heading candidate for the vehicle is generated in units of a first angle within the heading search range of angles.

The instructions, when executed by the processor, may further cause the apparatus to: set a heading search range of angles for the vehicle in the map information; and maintain a previous state of a lane based on no new lane being detected in the heading search range of angles.

The heading candidate group for the vehicle may include at least one heading candidate for the vehicle; and the at least one heading candidate for the vehicle is generated in units of a second angle within a range of a heading rotation angle of the vehicle set based on the initial GNSS location.

The instructions, when executed by the processor, may further cause the apparatus to: match the second grid map with the first grid map by rotating the first grid map by a predetermined angle up to a preset angle range, determine a correlation value between the second grid map and the first grid map of each rotation, determine a rotation of the first grid map having a correlation peak, and set the initial location of the vehicle based on the correlation peak being greater than or equal to a threshold correlation peak.

Based on a length matched between the first grid map and the second grid map, which are calculated based on the set initial location of the vehicle, being greater than or equal to a preset reference length, the instructions, when executed by the processor, may further cause the apparatus to set the initial location of the vehicle.

The instructions, when executed by the processor, may further cause the apparatus to: set the initial location of the vehicle two times, wherein: based on a first of the two times set initial location of the vehicle, a first position of the vehicle is determined; and based on a second of the two times set initial location of the vehicle, a second position of the vehicle is determined; determine a probability of similarity between the first position of the vehicle and the second position of the vehicle; and complete a determination of the initial location of the vehicle based on the determined probability of similarity being greater than or equal to a predetermined value.

The instructions, when executed by the processor, may further cause the apparatus to: accumulate the sensing information at least once; and generate the second grid map based on the accumulated sensing information.

According to the present disclosure, a method may comprise: receiving, by a processor, map information associated with an initial global navigation satellite system (GNSS) location; generating, based on the map information associated with the initial GNSS location, a first grid map and an initial location of the vehicle; generating, based on sensing information from a sensor, a second grid map; determining, based on a comparison of the first grid map and the second grid map, an adjusted location of the vehicle; and outputting, based on the adjusted location of the vehicle, adjusted map information for a driving operation of the vehicle.

The outputting the adjusted map information may comprise: displaying, based on the adjusted location of the vehicle, an adjusted driving path of the vehicle for an autonomous driving operation of the vehicle.

The adjusted location of the vehicle may comprise at least one of: an adjusted location of the vehicle on an a road, or an adjusted driving direction of the vehicle.

The sensing information may comprise at least one of: building images, street view images, intersection images, and/or other feature points of the surrounding images of the vehicle. In addition to the GPS map data and metadata associated with one or more locations in the GPS map, the map information may comprise at least one of: building images, street view images, intersection images, and/or other feature points in a region around the initial GNSS location.

The first grid and the initial GNSS location may be determined based on the map information. The second grid may be determined based on the sensing information. Based on an adjustment (e.g., rotation) of at least one of the first grid or the second grid, the correlation between the first grid and the second grid may be determined. At a correlation peak, the first grid may match with the second grid, and the adjusted location of the vehicle may be determined based on the correlation peak.

In an autonomous driving mode, the autonomous driving system may determine a proper driving path based on the adjusted location of the vehicle and/or an adjusted driving direction of the vehicle on the adjusted map information. In a non-autonomous driving mode, a driver of the vehicle may easily determine the right driving direction based on the adjusted location of the vehicle and/or an adjusted driving direction of the vehicle on the adjusted map information.

These and other features and advantages are described in greater detail below.

### BRIEF DESCRIPTION OF THE DRAWINGS

The accompanying drawings, which are included to provide a further understanding of the disclosure and are incorporated in and constitute a part of this application, show example (s) of the disclosure and together with the description serve to explain the principle of the disclosure. In the drawings:

FIG. 1 shows an example of a method of determining an initial location according to an example of the present disclosure;

FIG. 2 shows an example of an apparatus for determining an initial location of a vehicle according to an example of the present disclosure;

FIG. 3 shows an example of a method of determining the initial location of the vehicle according to an example of the present disclosure;

FIG. 4 shows an example of a method of extracting a heading search region according to an example of the present disclosure;

FIGS. 5A, 5B, 5C, and 5D show examples of a method of matching a grid map according to an example of the present disclosure;

FIGS. 6A, 6B, 6C, and 6D show examples of a method of matching the grid map according to another example of the present disclosure; and

FIGS. 7A and 7B shows an example of a matched grid map according to an example of the present disclosure.

### DETAILED DESCRIPTION OF THE DRAWINGS

Hereinafter, examples of the present disclosure will be described in detail with reference to the accompanying drawings, and the same or similar elements will be given the same reference numerals regardless of reference symbols, and redundant description thereof will be omitted.

The term “unit” for an element used in the following description is assigned and used interchangeably in consideration of convenience of description, and thus does not introduce physical division or separation. Illustratively, an “oo unit” and an “xx unit” may be elements performing different functions. However, in an example, functions thereof may be performed in parallel or sequentially in time in the same microprocessor without physical separation or division, which is not excluded by the term “unit.” Further, this description is similarly applied to the term “module.”

Further, in describing the examples disclosed in the present specification, when it is determined that a detailed description of a related publicly known technology may obscure the gist of the examples disclosed in the present specification, the detailed description thereof will be omitted.

In addition, the accompanying drawings are only for easy understanding of the examples disclosed in this specification, the technical idea disclosed in this specification is not limited by the accompanying drawings, and it should be understood that all modifications, equivalents, and substitutes included in the spirit and scope of the present disclosure are covered.

Although terms including ordinal numbers, such as “first”, “second”, etc., may be used herein to describe various elements, the elements are not limited by these terms. These terms are generally only used to distinguish one element from another. In particular, it should not be construed as establishing an order among elements based solely on names thereof.

In addition, the criteria for “up/upper” or “down/lower” are naturally determined from properties of respective elements or therebetween, used only to indicate a relative positional relationship between elements based on appearance shown in the figures for convenience in principle unless stated otherwise in the specification, and should not be construed as limiting locations of actual elements.

For example, “B located on A” only indicates that B is shown as being located on A in a figure unless stated otherwise or B needs to be located on A due to a property of A or B. In an actual product, etc., B may be located below A, or B and A may be placed side by side.

The term “and/or” is used to include any combination of a plurality of items that are the subject matter. For example, “A and/or B” inclusively means all three cases such as “A,” “B,” and “A and B.”

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art, and unless explicitly defined in this application, the terms should not be interpreted as ideal or excessively formal meanings.

In addition, the term “unit” or “control unit” is merely a widely used term for naming a controller that outputs a control value or an instruction for a specific function to another element, and does not mean a generic functional unit. For example, each unit or control unit may include an input/output device for exchanging signals with another controller or sensor to control a function assigned thereto, a memory that stores an operating system, a logic command, input/output information, etc., and one or more processors that perform determination, calculation, decision, etc. necessary for controlling a function assigned thereto.

Hereinafter, the working principle and examples of the present disclosure will be described with reference to the accompanying drawings.

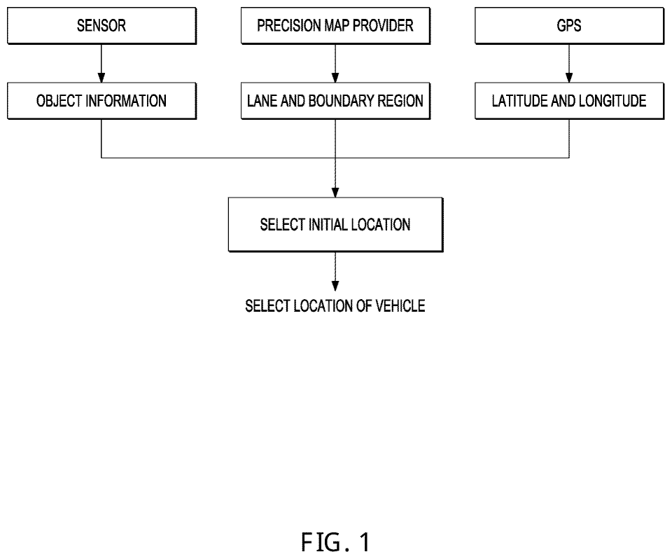

FIG. 1 shows an example of a method of determining an initial location according to an example of the present disclosure.

Referring to FIG. 1, in the method of determining an initial location, object information around the vehicle may be received from a sensor, lane and boundary region information may be received from a precision map provider, and latitude and longitude information may be received from the GPS. In this way, the initial location of the vehicle may be selected, and the location of the vehicle may be determined based on the selected initial location. Here, the sensor may be referred to as a LiDAR sensor.

As described above, the location may be determined through LiDAR-map matching based on a location of the GPS based on the GPS, the sensor, and the precision map provider. If a GPS error is relatively large during LiDAR line-map line matching, incorrect matching may occur.

For example, if a service starts at a place where the initial location is set, there may be significant limitations in providing an autonomous driving service, and restarting the service may be challenging if a system error occurs in the middle of the autonomous driving service.

Further, if an initial location determination range is relatively wide due to a GPS error, a relatively large amount of data and real number calculation may cause a large calculation burden (e.g., power and time) and reduce a processing speed.

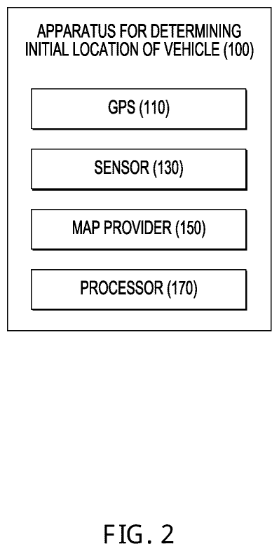

FIG. 2 shows an example of an apparatus for determining an initial location of a vehicle according to an example of the present disclosure.

Referring to FIG. 2, the apparatus 100 for determining the initial location of the vehicle may include a GNSS 110, a sensor 130, a map provider 150, and a processor 200.

The GNSS 110 includes a GNSS receiver configured to receive navigation information (navigation messages) broadcast from satellites, and utilizes the navigation information (GNSS information, GNSS signals, and satellite signals) to receive a current location, latitude, longitude, etc. of a vehicle 10.

The sensor 130 may measure a lane by recognizing the lane from a sensor or a camera provided in the vehicle 10. The sensor or the camera provided in the vehicle 10 may be mounted on the vehicle 10 to acquire surrounding images (front images, rear images, side images, etc.) of the vehicle 10. For example, the camera may include a single camera, a stereoscopic camera, an omnidirectional camera, a monocular camera, etc.

The sensor 130 detects information about an object located around the vehicle 10, and may include radio detection and ranging (RADAR), light detection and ranging (LiDAR), an ultrasonic sensor, an infrared sensor, etc.

The object information may include a speed of the object, a location of the object, size information of the object, and distance information between the vehicle and the object according to detection of the object present around the vehicle.

The map provider 150 provides a map stored in the vehicle 10, and the map may include lane information, location information obtained by measuring surrounding buildings, landmarks, etc.

The map provider 150 may receive a map through an external server, etc. For example, the map may include a precision map, a lattice map, an entire map, a local map, etc.

The processor 170 may control the GNSS 110, the sensor 130, and the map provider 150. The present disclosure is not limited thereto, and driving of the vehicle 10 or a plurality of parts incorporated in the vehicle 10 may be individually controlled or combined and controlled.

For example, the processor 170 may receive an initial location of the GNSS from the GNSS 110 to call map information related to the initial location of the GNSS, generate a first grid map based on the map information, and receive sensing information from the sensor to generate a second grid map based on the sensing information.

The first grid map may be referred to as a map grid map or a global grid map. The first grid map may be generated based on map information under the control of the processor 170 and may be generated by applying a heading search range to be described later.

The second grid map may be referred to as a sensor grid map or a local grid map. The second grid map may accumulate sensing information at least once under the control of the processor 170 and may be generated based on the accumulated sensing information. For example, the second grid map may be generated after accumulating LiDAR sensor information in the sensor 130 under the control of the processor 170. In this way, the processor 170 generates the second grid map based on the accumulated sensor information, so that LiDAR sensor information not appearing by being temporarily obscured by a nearby driving vehicle or a nearby obstacle may be easily ensured.

The first grid map or the second grid map may be formed in a predetermined size. At this time, one grid may be formed in a size of approximately 0.5 meters (m) or more and 1.5 meters (m) or less. For example, if the grid size is 0.5 meters (m) or less, a lot of data may be required to form the first grid map or the second grid map, and if the grid size is 1.5 meters (m) or more, map accuracy may be reduced. In consideration thereof, preferably, one grid may be formed in a size of approximately 1 meter (m). The present disclosure is not limited thereto, and the grid size representing one unit may be changed to slightly different sizes in consideration of map information, precision map information, area map information, sensor information, etc.

The processor 170 may match the first grid map and the second grid map to detect a correlation peak with respect to the initial location of the vehicle. The processor 170 may determine whether to set the initial location of the vehicle in response to the detected correlation peak. A detailed description thereof will be given later.

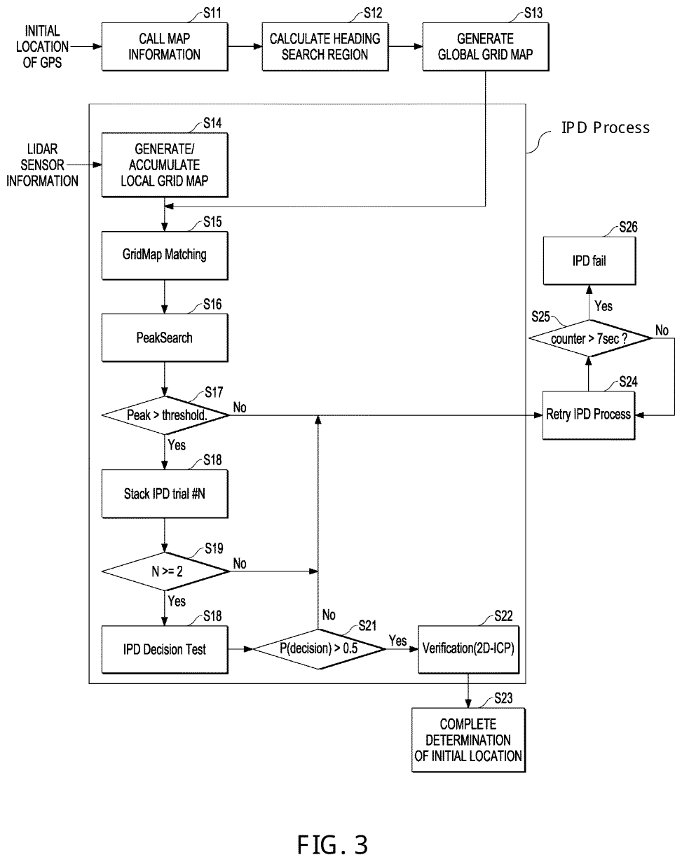

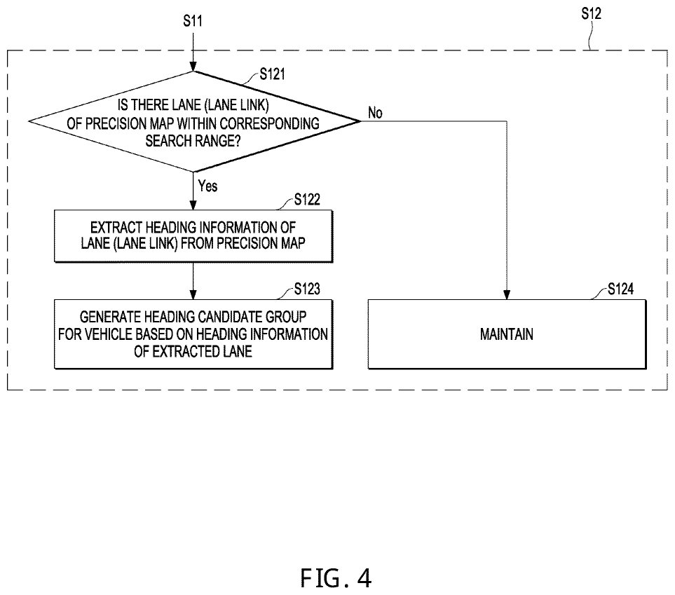

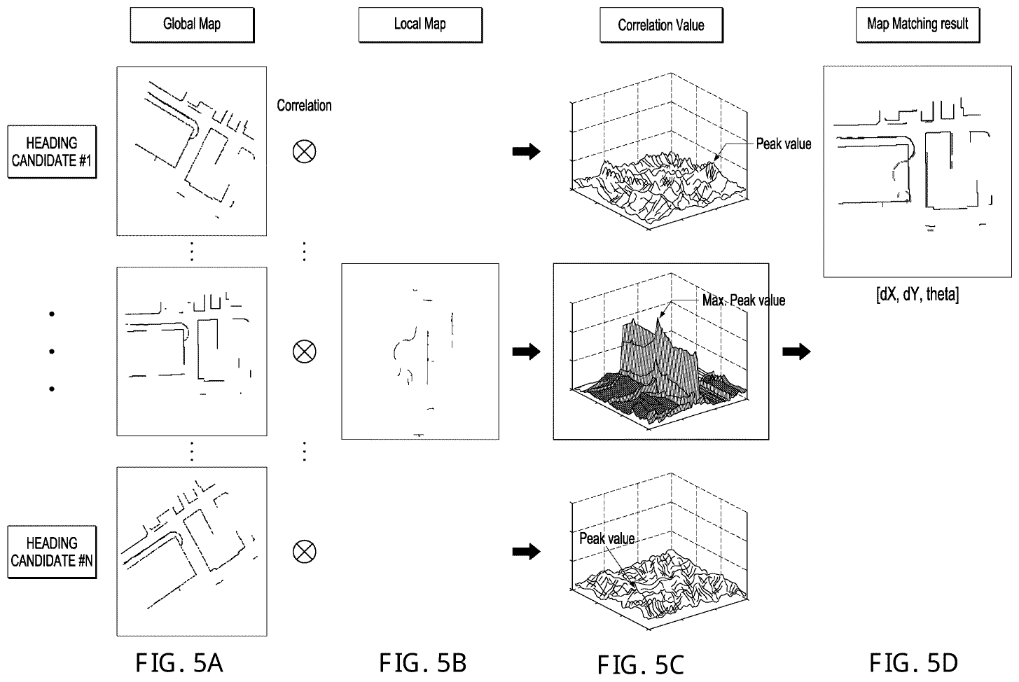

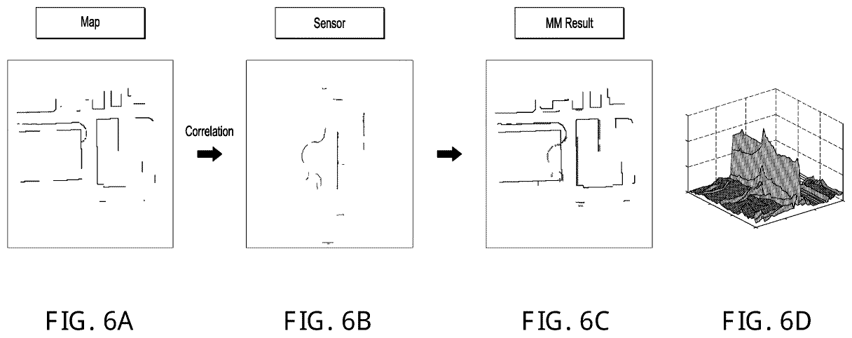

FIG. 3 shows an example of a method of determining the initial location of the vehicle according to an example of the present disclosure. FIG. 4 shows an example of a method of extracting a heading search region according to an example of the present disclosure. FIGS. 5 and 6 are diagrams each for describing a method of matching a grid map according to an example of the present disclosure.

Referring to FIG. 3, the method of determining the initial location of the vehicle according to the example of the present disclosure is as follows.

The apparatus 100 for determining the initial location of the vehicle may receive an initial location of the GNSS 110 from the GNSS 110 under the control of the processor 170. Here, an error range for the initial location of the GNSS 110 may be set to minus (−) 15 meters (m) or more and plus (+) 15 meters (m) or less. That is, the error range of the initial location of the GNSS may be set to minus (−) 15 meters (m) or more and plus (+) 15 meters (m) or less.

The processor 170 may call map information related to the initial location of the GNSS 110 from the map provider 150 (S11).

The processor 170 may set or calculate a heading search range from the called map information (S12). The heading search range may be referred to as a heading search region.

Referring to FIG. 4, the processor 170 may check or detect whether there is a lane (lane link) of the precision map within the heading search range (S121). That is, the processor 170 may set an error range of the initial location of the GNSS as the heading search range, and check or detect the lane (lane link) of the precision map within the heading search range.

If the lane (lane link) of the precision map is checked or detected within the heading search range, the processor 170 may extract heading information of the lane (lane link) detected from the precision map (S122).

If the heading information of the lane is extracted, the processor 170 may generate a heading candidate group for a vehicle based on the extracted heading information of the lane (S123).

The heading candidate group for the vehicle may include at least one heading candidate for the vehicle. Here, the heading candidate for the vehicle may be generated in units of a first angle within the heading search range of the lane set based on heading information of the lane under the control of the processor 170. At this time, under the assumption that the vehicle is parked and stopped almost parallel to the lane, +−20 degrees based on the lane may be set as the heading search range.

That is, the heading search range may be set to minus (−) 20 degrees or more and plus (+) 20 degrees or less. The units of the first angle may be set to units of approximately 2 degrees.

For example, the processor 170 may generate a heading candidate for the vehicle while rotating the heading search range of the lane set to approximately minus (−) 20 degrees or more and plus (+) 20 degrees or less based on the heading information of the lane in units of 2 degrees.

Accordingly, the processor 170 may generate heading candidates for up to 20 vehicles while rotating in units of the first angle within the heading search range of the lane.

On the other hand, the processor 170 may maintain the lane if no lane is detected within the heading search range (S124).

The heading candidate group for the vehicle may include at least one heading candidate for the vehicle. As shown in FIG. 5A, under the control of the processor 170, the heading candidate for the vehicle may be generated in units of a second angle within a range of a heading rotation angle of the vehicle set based on the initial location of the GNSS.

For example, in a section such as a crossroad, the range of the heading rotation angle of the vehicle may be set to 0 degrees or more and plus (+) 360 degrees or less. The units of the second angle may be set to units of approximately 2 degrees.

Accordingly, the processor 170 may generate heading candidates for up to 180 vehicles while rotating in units of the second angle within the range of the heading rotation angle of the vehicle.

Thereafter, the processor 170 may generate a global grid map using a heading search range for the set vehicle, a heading candidate group for the vehicle generated based on the heading search range, etc. (S13). The global grid map may be referred to as the first grid map.

In addition, the processor 170 may generate a local grid map based on sensing information provided from the sensor 130 (S14). For example, as shown in FIG. 5B, the local grid map may be generated based on accumulated LiDAR sensor information by accumulating the LiDAR sensor information at least once under the control of the processor 170. The processor 170 may easily ensure even LiDAR sensor information that is obscured by a nearby driving vehicle or a nearby obstacle by generating the local grid map based on the accumulated LiDAR sensor information.

According to a correlation result of the global grid map, which is the first grid map for each heading candidate generated in FIG. 5A, and the local grid map, which is the second grid map generated in FIG. 5B, FIG. 5C may calculate a correlation value of the global grid map and the local grid map (S15). For example, if the correlation value between the global grid map and the local grid map is a maximum value as a correlation result between the global grid map and the local grid map, the processor 170 may determine that the location of the ego vehicle is accurate.

That is, the processor 170 may detect a correlation peak from the correlation result (S16). The processor 170 may search for a heading candidate having a maximum value among correlation peaks detected for each heading candidate, and extract horizontal and vertical indexes of the correlation result, thereby estimating a heading error, a lateral error (dX), and a longitudinal error (dY) of the initial location of the GNSS.

As shown in FIG. 5D, if an accurate initial location of the GNSS is estimated, the global grid map and the local grid map may be exactly matched.

As shown in FIG. 5C, if the detected correlation peak is greater than or equal to a preset correlation peak, the processor 170 may set the initial location of the vehicle (S17). For example, if the detected correlation peak is greater than or equal to the preset correlation peak (Max (corrValue)>threshold), the processor 170 may estimate that the correlation peak is a maximum value. Upon determining that the correlation peak is the maximum value, the processor 170 may determine that matching of the first grid map and the second grid map is completed, and generate a third grid map based thereon. Here, the third grid map may be a grid map generated if matching of the first grid map and the second grid map is completed.

Thereafter, if matching of the first grid map and the second grid map is completed and the third grid map is generated, the processor 170 may perform precise positioning based on an iterative close point (ICP). A grid size of the third grid map is set to 1 meter (m), so that the third grid map may have accuracy of 1 meter (m) or less.

The processor 170 may perform precise positioning by detecting heading (theta), lateral direction (dX), and longitudinal direction (dY) of the vehicle that may be best matched between points of the third grid map using the ICP within an error range of 1 meter (m).

Accordingly, the processor 170 may detect the precise vehicle heading in units of real numbers.

In addition, when a matching length matched between the first grid map and the second grid map, which are calculated based on the set initial location of the vehicle, is equal to or greater than a preset reference length, the processor 170 may determine the initial location of the vehicle (S18). For example, the processor 170 may determine the initial location of the vehicle if the matching length of the matched third grid map is greater than or equal to the predetermined reference length.

For example, if the matching length of the third grid map matched by applying the ICP is equal to or greater than the predetermined reference length, the processor 170 may determine the initial location (IPD, Initial Pose Decision).

As described above, if the initial location is determined, the processor 170 may test determination of the initial location (S20) by repeating determination of whether to set the initial location at least twice (S19). That is, the processor 170 may calculate a probability of similarity by determining whether to set the initial location of the vehicle at least twice.

If the calculated probability of similarity is greater than or equal to 0.5 (S21), the processor 170 may check the initial location of the vehicle (S22), and complete determination of the initial location of the vehicle (S23).

For example, the processor 170 may determine a degree of similarity between results of determining heading/horizontal/vertical positioning. For example, the degree of similarity may be defined as a probability of similarity P=(number of similar results/total number of trials).

If the detected correlation peak is equal to or less than a predetermined correlation peak, the processor 170 may continue to detect the correlation peak (S24). The processor continuously detects the correlation peak, and may determine that the correlation peak cannot be detected (S26) if a predetermined time elapses (S25). Here, the predetermined time may be approximately 7 seconds (sec).

FIGS. 6A, 6B, 6C, and 6D show examples of a method of matching the grid map according to another example of the present disclosure.

As shown in FIG. 6A, if there is information on a heading candidate for a vehicle, the processor 170 may create a global grid map based on this information. That is, the processor 170 may solve matching ambiguity caused by an ego vehicle heading error by performing calculation using one vehicle heading candidate when using initial ego vehicle heading information.

Description of FIGS. 6B, 6C, and 6D may be sufficiently inferred through FIGS. 5B, 5C, and 5D, and thus will be omitted here.

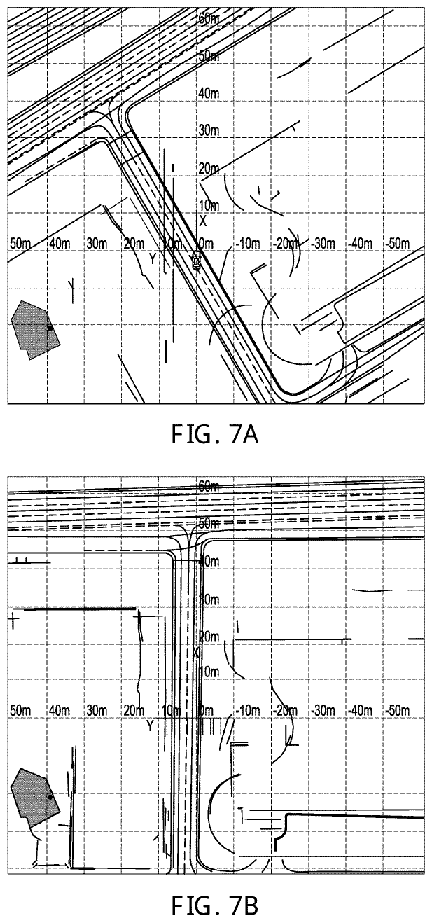

FIGS. 7A and 7B show examples of a matched grid map according to an example of the present disclosure.

FIG. 7A is a screen before driving the apparatus for determining the initial location of the vehicle according to the example of the present disclosure, and FIG. 7B is a screen after driving the apparatus for determining the initial location of the vehicle according to the example of the present disclosure.

As shown in FIG. 7B, a result of accurately determining the initial location of the vehicle may be known.

As described above, the apparatus for determining the initial location of the vehicle according to the example of the present disclosure may convert LiDAR data (information) into a grid map to reduce a data size in binary, use entire shape information through LiDAR surface-map surface matching to reduce an initial location determination range, and rapidly and accurately determine the initial location through LiDAR line-map line matching within the reduced range.

Accordingly, the present disclosure is directed to a method and apparatus for determining an initial location of a vehicle that substantially obviate one or more problems (e.g., inaccuracies, latencies, power inefficiencies, etc.).

According to examples, an object is to provide an apparatus and method for determining an initial location of a vehicle capable of converting LiDAR data into a grid map to reduce a data size in binary, using entire shape information through LiDAR surface-map surface matching to reduce an initial location determination range, and rapidly and accurately determining the initial location through LiDAR line-map line matching within the reduced range.

Technical problems to be solved in the examples are not limited to the above-mentioned technical problems, and other technical problems not mentioned herein will be clearly understood by those skilled in the art from the description below.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as broadly described herein, a method of determining an initial location of a vehicle includes receiving map information related to an initial global navigation satellite system (GNSS) location, and generating a first grid map based on the map information under control of a processor, receiving sensing information from a sensor to generate a second grid map based on the sensing information under control of the processor, matching the first grid map and the second grid map to determine the initial location of the vehicle under control of the processor, and determining whether to set the initial location of the vehicle in response to a result of the matching under control of the processor.

In at least one example of the present disclosure, the matching the first grid map and the second grid map may include matching the second grid map with the first grid map by rotating the first grid map by a predetermined angle up to a preset angle range, determining a correlation value between the second grid map and the first grid map of each rotation, and determining a rotation of the first grid map having a correlation peak.

In at least one example of the present disclosure, generating the first grid map comprises setting a heading search range for the vehicle in the called map information under control of the processor, and determining heading information of a detected lane from the lane when the lane is detected within the heading search range, and generating a heading candidate group for the vehicle based on the heading information of the lane under control of the processor.

In at least one example of the present disclosure, the heading candidate group for the vehicle comprises at least one heading candidate for the vehicle, and the at least one heading candidate for the vehicle is generated such that one heading candidate is generated per one increment of a first angle within a heading search range of the lane set based on the heading information of the lane under control of the processor.

In at least one example of the present disclosure, generating the first grid map comprises maintaining a previous state if the lane is not detected in the heading search range under control of the processor.

In at least one example of the present disclosure, the heading candidate group for the vehicle comprises at least one heading candidate for the vehicle, and the at least one heading candidate for the vehicle is generated such that one heading candidate is generated in one increment of a second angle within a range of a heading rotation angle of the vehicle set based on the initial location of the GNSS under control of the processor.

In at least one example of the present disclosure, determining whether to set the initial location of the vehicle comprises setting the initial location of the vehicle if the detected correlation peak is greater than or equal to a preset correlation peak under control of the processor.

In at least one example of the present disclosure, determining whether to set the initial location of the vehicle comprises setting the initial location of the vehicle when a matching length matched between the first grid map and the second grid map calculated based on the set initial location of the vehicle is greater than or equal to a preset reference length under control of the processor.

In at least one example of the present disclosure, determining whether to set the initial location of the vehicle comprises calculating a probability of similarity by determining whether to set the initial location of the vehicle at least once under control of the processor, and completing a determination of the initial location of the vehicle if the calculated probability of similarity is greater than or equal to a predetermined value, e.g., 0.5.

In at least one example of the present disclosure, generating the second grid map comprises accumulating the sensing information at least once under control of the processor, and generating the second grid map based on the accumulated sensing information.

In another example of the present disclosure, a computer-readable recording medium records a program for executing one of the methods described above.

In still another example of the present disclosure, an apparatus for determining an initial location of a vehicle comprises a processor, a GNSS configured receive navigation information under control of the processor, a sensor configured to sense a lane (lane link) and an object around the vehicle under control of the processor, and a map provider including map information stored in advance, wherein the processor is configured to receive map information related to the initial GNSS location, and generates a first grid map based on the map information, receive sensing information from the sensor to generate a second grid map based on the sensing information, match the first grid map and the second grid map to determine the initial location of the vehicle, and determine whether to set the initial location of the vehicle in response to a result of the matching.

In at least one example apparatus of the present disclosure, the processor is further configured to set a heading search range for the vehicle in the called map information, and determine heading information of the detected lane from the lane if the lane is detected within the heading search range, and generate a heading candidate group for the vehicle based on the heading information of the lane.

In at least one example apparatus of the present disclosure, the heading candidate group for the vehicle includes at least one heading candidate for the vehicle, and the at least one heading candidate for the vehicle is generated such that one heading candidate is generated per one increment of a first angle within a heading search range of the lane set based on the heading information of the lane under control of the processor.

In at least one example apparatus of the present disclosure, the processor is further configured to maintain a previous state if the lane is not detected in the heading search range.

In at least one example apparatus of the present disclosure, the heading candidate group for the vehicle includes at least one heading candidate for the vehicle, and the at least one heading candidate for the vehicle is generated such that one heading candidate is generated in one increment of a second angle within a range of a heading rotation angle of the vehicle set based on the initial location of the GNSS under control of the processor.

In at least one example apparatus of the present disclosure, the processor is further configured to match the second grid map with the first grid map by rotating the first grid map by a predetermined angle up to a preset angle range, determine a correlation value between the second grid map and the first grid map of each rotation, determine a rotation of the first grid map having a correlation peak, and set the initial location of the vehicle if the correlation peak is greater than or equal to a preset correlation peak.

In at least one example apparatus of the present disclosure, when a matching length matched between the first grid map and the second grid map calculated based on the set initial location of the vehicle is greater than or equal to a preset reference length, the processor is further configured to set the initial location of the vehicle.

In at least one example apparatus of the present disclosure, the processor is further configured to calculate a probability of similarity by determining whether to set the initial location of the vehicle at least once, and complete a determination of the initial location of the vehicle if the calculated probability of similarity is greater than or equal to a predetermined value, e.g., 0.5.

In at least one example apparatus of the present disclosure, the processor is further configured to accumulate the sensing information at least once, and generate the second grid map based on the accumulated sensing information.

It is to be understood that both the foregoing general description and the following detailed description of the present disclosure are exemplary and explanatory and are intended to provide further explanation of the disclosure as claimed.

The above-described examples may be implemented as a recording medium storing an instruction executable by a computer. The instruction may be stored as program code, and may create a program module to perform operations of the disclosed examples when executed by a processor. The recording medium may be implemented as computer-readable recording media.

The computer-readable recording media includes all types of recording media storing instructions that may be decoded by a computer. Examples thereof may include a read only memory (ROM), a random access memory (RAM), a magnetic tape, a magnetic disk, a flash memory, an optical data storage device, etc.

The apparatus and method for determining the initial location of the vehicle according to the example have effects of being able to convert LiDAR data (information) into a grid map to reduce a data size in binary, use entire shape information through LiDAR surface-map surface matching to reduce an initial location determination range, and rapidly and accurately determine the initial location through LiDAR line-map line matching within the reduced range.

In addition, the apparatus and method for determining the initial location of the vehicle according to the example have effects of being able to convert LiDAR data (information) into a grid map to reduce a data size in binary, use entire shape information through LiDAR surface-map surface matching to reduce an initial location determination and rapidly and accurately determine the initial location through LiDAR line-map line matching within the reduced range, thereby stably providing an autonomous driving service.

Effects obtainable in the present example are not limited to the effects mentioned above, and other effects not mentioned here may be clearly understood by those skilled in the art from the above description.

As describe above, the disclosed examples have been described with reference to the accompanying drawings. A person skilled in the art to which the present disclosure pertains will understand that the present disclosure may be implemented in a form different from that of the disclosed examples without changing the technical spirit or essential features of the present disclosure. The disclosed examples are illustrative and should not be restrictively construed.

What is claimed is:

1. A method comprising:
receiving, by a processor, map information associated with an initial global navigation satellite system (GNSS) location;
generating, based on the map information associated with the initial GNSS location, a first grid map;
generating, based on sensing information from a sensor, a second grid map;
determining, based on a comparison of the first grid map and the second grid map, an initial location of a vehicle; and
controlling, based on the initial location of the vehicle, a driving operation of the vehicle.

2. The method according to claim 1, wherein generating the first grid map comprises:
setting a heading search range of angles for the vehicle in the map information;
detecting a lane within the heading search range of angles;
determining, based on the detected lane, heading information associated with the detected lane; and
generating a heading candidate group for the vehicle based on the heading information of the detected lane.

3. The method according to claim 2, wherein:
the heading candidate group for the vehicle comprises at least one heading candidate for the vehicle; and
the at least one heading candidate for the vehicle is generated in units of a first angle within the heading search range of angles.

4. The method according to claim 1, wherein generating the first grid map comprises:
setting a heading search range of angles for the vehicle in the map information; and
maintaining a previous state of a lane based on no new lane being detected in the heading search range of angles.

5. The method according to claim 2, wherein:
the heading candidate group for the vehicle comprises at least one heading candidate for the vehicle; and
the at least one heading candidate for the vehicle is generated in units of a second angle within a range of a heading rotation angle of the vehicle set based on the initial GNSS location.

6. The method according to claim 1, further comprising:
matching the second grid map with the first grid map by rotating the first grid map by a predetermined angle up to a preset angle range,
determining a correlation value between the second grid map and the first grid map of each rotation, and
determining a rotation of the first grid map having a correlation peak.

7. The method according to claim 6, further comprising determining, based on the comparison, whether to set the initial location of the vehicle by setting the initial location of the vehicle based on the correlation peak being greater than or equal to a threshold correlation peak.

8. The method according to claim 7, further comprising determining, based on the comparison, whether to set the initial location of the vehicle by setting the initial location of the vehicle when a length matched between the first grid map and the second grid map, which are calculated based on the set initial location of the vehicle, is greater than or equal to a preset reference length.

9. The method according to claim 1, further comprising determining, based on the comparison, whether to set the initial location of the vehicle by:
setting the initial location of the vehicle two times, wherein:
based on a first of the two times set initial location of the vehicle, a first position of the vehicle is determined; and
based on a second of the two times set initial location of the vehicle, a second position of the vehicle is determined; determining a probability of similarity between the first position of the vehicle and the second position of the vehicle; and
completing a determination of the initial location of the vehicle based on the determined probability of similarity being greater than or equal to a predetermined value.

10. The method according to claim 1, wherein generating the second grid map comprises:
accumulating the sensing information at least once under control of the processor; and
generating the second grid map based on the accumulated sensing information.

11. A non-transitory computer-readable recording medium storing instructions, that, when executed, cause performing the method according to the claim 1.

12. An apparatus comprising:
a processor; and
memory storing instructions, that, when executed by the processor, cause the apparatus to:
receive map information associated with an initial global navigation satellite system (GNSS) location;
generate, based on the map information associated with the initial GNSS location, a first grid map;
generate, based on sensing information from a sensor, a second grid map;
determine, based on a comparison of the first grid map and the second grid map, an initial location of a vehicle; and
control, based on the initial location of the vehicle, a driving operation of the vehicle.

13. The apparatus according to claim 12, wherein the instructions, when executed by the processor, further cause the apparatus to:
set a heading search range of angles for the vehicle in the map information;
detect a lane within the heading search range of angles;
determine, based on the detected lane, heading information associated the detected lane; and
generate a heading candidate group for the vehicle based on the heading information.

14. The apparatus according to claim 13, wherein:
the heading candidate group for the vehicle comprises at least one heading candidate for the vehicle; and
the at least one heading candidate for the vehicle is generated in units of a first angle within the heading search range of angles.

15. The apparatus according to claim 12, wherein the instructions, when executed by the processor, further cause the apparatus to:
set a heading search range of angles for the vehicle in the map information; and
maintain a previous state of a lane based on no new lane being detected in the heading search range of angles.

16. The apparatus according to claim 13, wherein:
the heading candidate group for the vehicle includes at least one heading candidate for the vehicle; and
the at least one heading candidate for the vehicle is generated in units of a second angle within a range of a heading rotation angle of the vehicle set based on the initial GNSS location.

17. The apparatus according to claim 12, wherein the instructions, when executed by the processor, further cause the apparatus to:
match the second grid map with the first grid map by rotating the first grid map by a predetermined angle up to a preset angle range,
determine a correlation value between the second grid map and the first grid map of each rotation,
determine a rotation of the first grid map having a correlation peak, and
set the initial location of the vehicle based on the correlation peak being greater than or equal to a threshold correlation peak.

18. The apparatus according to claim 17, wherein, based on a length matched between the first grid map and the second grid map, which are calculated based on the set initial location of the vehicle, being greater than or equal to a preset reference length, the instructions, when executed by the processor further cause the apparatus to set the initial location of the vehicle.

19. The apparatus according to claim 12, wherein the instructions, when executed by the processor, further cause the apparatus to:
set the initial location of the vehicle two times, wherein:
based on a first of the two times set initial location of the vehicle, a first position of the vehicle is determined; and
based on a second of the two times set initial location of the vehicle, a second position of the vehicle is determined;
determine a probability of similarity between the first position of the vehicle and the second position of the vehicle; and
complete a determination of the initial location of the vehicle based on the determined probability of similarity being greater than or equal to a predetermined value.

20. The apparatus according to claim 12, wherein the instructions, when executed by the processor, further cause the apparatus to:
accumulate the sensing information at least once; and
generate the second grid map based on the accumulated sensing information.
